(19) United States
(12) Patent Application Publication
(10) Pub. No.: US 2013/0167059 A1
(43) Pub. Date: Jun. 27, 2013

(54) USER INTERFACE FOR DISPLAYING AND REFINING SEARCH RESULTS

(71) Applicant: Martin Legris, Montreal (CA)

(72) Inventor: Martin Legris, Montreal (CA)

(73) Assignee: NEW COMMERCE SOLUTIONS INC., Monteal (CA)

(21) Appl. No.: 13/333,481

(22) Filed: Dec. 21, 2011

(51) Int. Cl. G06F 3/048

(52) U.S. Cl. 715/769

(57) ABSTRACT

The present document describes a graphical user interface (GUI) for displaying and refining search results. The search results are received and stored in a queue along with a coefficient of relevance associated with each search result. The search results with the highest coefficients are displayed within the edge. A function indicating a user preference (like, dislike, etc.) is associated with the edge of the GUI, whereby when the user drags a search result toward the edge, the coefficients of the related search results are modified in accordance with a similarity factor between the dragged search result and the related search results. For example, if the user preference associated with the edge indicates that the user likes the dragged search result, the interface would increase the coefficient of the related search results and refine the search results displayed within the edge of the interface based on the modified coefficients.

### BACKGROUND

(a) Field

The subject matter disclosed generally relates to a user interface.

(b) Related Prior Art

Conventional search interfaces allow the user to type in a search query and hit the search button to retrieve a list of products. The initial search may provide search results including a plurality of items. The user may open and view the first item, and move to the next item if a “next” button is provided. The user may go back to the main results page using breadcrumbs to view the other items (Breadcrumbs is a navigation aid used in user interfaces which provides links back to each previous page the user navigated through to get to the current page).

These activities are time consuming and confusing for the average consumer. The challenge also increases when the page is being surfed using a portable device having a smaller screen such as a portable phone, IPAD, IPOD and the like.

In particular, conventional user interfaces do not fit neatly in a mobile browser's display, and displays having limited screen sizes. Additionally, switching screens on a mobile phone can be more confusing because the navigational context is restricted on the mobile interface. For example the whole top bar which offers consistency throughout the site cannot exist on the mobile interface because of the need to dedicate screen real-estate (space) to practical information. In many cases even putting the logo of the store becomes cumbersome.

Moreover, the navigation possibilities on smaller screens are also limited. For example, it is not possible to go back through breadcrumbs, visit similar items, visit popular items in a category, and visit product recommendations.

Therefore, it is necessary to simplify the task of refining a search and to reduce switching screens in a search interface.

### SUMMARY

According to an embodiment, there is provided a computing device for performing a product search comprising: a processor; a memory storing one or more programs, the one or more programs comprising instructions which, when executed by the processor of the computing device, cause the computing device to:
display a search interface defining a plurality of edges on a display device;
receive a search query;
perform a search for products matching the search query;
display nodes representative of the products within the edges of the search interface;
detect a common characteristic between the products represented by the nodes;
provide and display a visual link between the nodes having the common characteristic;
display the common characteristic in a tag that is associated with the visual link.

In an embodiment, the instructions further cause the computing device to: receive a list of products each having a coefficient associated therewith; store the products in a queue in an order which is representative of a magnitude of their coefficients; and display a subset of the products, as nodes representative thereof, in the search interface, the nodes displayed having coefficients with the highest magnitude.

In an further embodiment, the display nodes step takes into account the space allocated for the search interface on the display device to determine the number of nodes displayed in the search interface.

In an embodiment, the instructions cause the computing device to associate a function indicating a user preference with one or more of the plurality of edges, wherein by dragging a node toward a selected edge and activating the function associated with the selected edge the computing device refines the products displayed in the search interface based on the user preference associated with the selected edge.

In another embodiment, if the user preference associated with the selected edge indicates that the user likes the product represented by the dragged node, the instructions cause the computing device to: increase the magnitude of the coefficient associated to the product represented by the dragged node; modify the magnitude of the coefficient of each product related to the product represented by the dragged node in accordance with a factor of similarity between the product represented by the dragged node and the related product; reorder the queue in accordance with the modified magnitudes; and modify the nodes displayed in the search interface including removing the dragged node and adding a new node representing a new product based on the reordered queue.

In an embodiment, the instructions cause the computing device to: remove visual links and tags related to the dragged node; and display new visual links and new tags related to the new node added in the search interface.

In another embodiment, if the user preference associated with the selected edge indicates that the user dislikes the product represented by the dragged node, the instructions cause the computing device to: decrease the magnitude of the coefficient associated to the product represented by the dragged node; modify the magnitude of the coefficient of each product related to the product represented by the dragged node in accordance with a factor of similarity between the product represented by the dragged node and the related product; reorder the queue in accordance with the modified magnitudes; and modify the nodes displayed in the search interface including removing the dragged node and adding a new node representing a new product based on the reordered queue.

In yet another embodiment, the instructions cause the computing device to: remove visual links and tags related to the dragged node; and display new visual links and new tags related to the new node added in the search interface.

In a further embodiment, if the user preference associated with the selected edge indicates that the user wants to ignore/discard the product represented by the dragged node, the instructions cause the computing device to: remove the product represented by the dragged node from the search interface; modify the queue by removing the product represented by the dragged node; and add to the search interface a new represented by the dragged node from the modified queue.

If the user preference associated with the selected edge indicates that the user wants to share his preference concerning the product represented by the dragged node, the instructions may cause the computing device to: display a logo of one or more social networks; and send the preference concerning the product for posting on a user profile at selected social networks.

If the user preference associated with the selected edge indicates that the user wants to preview the product represented by the dragged node, the instructions may cause the computing device to: select a computer program with which a sample of the product may be previewed; preview the sample using the computer program.

In an embodiment, the instructions cause the computing device to highlight the selected edge and the function associated therewith when a node is dragged toward the selected edge.

In one embodiment, the function is activated when the dragged node is brought in contact with the selected edge, the instructions causing the computing device to: measure a direction of movement of the dragged node to determine the destination edge; highlight the edge and the function associated therewith; and activate the function associated with the destination edge when the dragged node is brought in contact with the destination edge.

In another embodiment, the function is activated when the dragged node is accelerated [and released] toward the selected edge, the instructions causing the computing device to: measure a direction of movement of the dragged node to determine the destination edge; highlight the edge and the function associated therewith; measure an acceleration of a dragging movement; and activate the function associated with the destination edge when the acceleration exceeds a predetermined threshold.

In an embodiment, the edges of the search interface comprise a like edge and a dislike edge, for at least one edge of the like edge and dislike edge, the instructions cause the computing device to: associate a first score to a first end of the at least one edge, the first score representing the lowest degree of liking in the like edge or disliking in the dislike edge; associate a second score to a second end of the at least one edge, the second score representing the highest degree of liking in the like edge or disliking in the dislike edge; detect an intersection point between a dragging trajectory of the dragged node and the at least one edge; modify the coefficient of the selected product in accordance with a position of the intersection point between the first end and the second of the at least one edge.

The product may be one of: artist, author, singer, dancer, music composer, band, actor, music album, song, painting, book, movie, game, electronic device.

In an embodiment, the user may personalize the search interface by associating the desired function and user preference to the desired edge or portion of an edge.

In another aspect there is provided a graphical user interface (interface) on a computing device comprising a memory having stored thereon computer instructions and a queue for storing search results and a coefficient for each search result indicating a relevance of that search result to a search query, and a processor for executing the instructions for implementing the interface on a display device, the interface comprising: a display area for displaying search results having the highest coefficients; and a periphery surrounding the display area, the periphery comprising an edge at or near the periphery having a function associated therewith, the function indicating a user preference; wherein the function is activated by dragging a search result toward the edge.

In an embodiment, the edge is divided into portions and different functions are associated with different edge portions, each function being activated when a search result is dragged toward the edge portion associated with that function.

In an embodiment, a first function associated with a first edge portion indicates that the user likes the dragged search result, wherein when the first function is activated the interface causes the computing device to: increase the coefficient of the dragged search result; modify the coefficient of each search result related to the dragged search result in accordance with a similarity factor between the dragged search result and the related search result; reorder the queue in accordance with the modified coefficients; and modify the search results displayed in the display area based on the reordered queue.

In an embodiment, a second function associated with a second edge portion indicates that the user dislikes the dragged search result, wherein when the second function is activated the interface causes the computing device to: decrease the coefficient of the dragged search result; modify the coefficient of each search result related to the dragged search result in accordance with a similarity factor between the dragged search result and the related search result; reorder the queue in accordance with the modified coefficients; modify the search results displayed in the display area based on the reordered queue.

In an embodiment, the search results comprise products having a specification sheet, wherein the search results may be refined by opening a specification sheet associated with a selected product and dragging a product characteristic listed in the specification sheet toward a desired edge portion to activate the function associated with the desired edge portion.

In another embodiment, the interface displays the search results, as icons representative thereof, in a cluster of icons including a visual link between icons having a common characteristic, and a tag indicating the common characteristic, the tag being associated with the visual link.

In a further embodiment, the search results may be refined by dragging the tag toward a desired edge portion, wherein the coefficients of the search results having the characteristic displayed in the dragged tag as a common characteristic are modified in accordance with the user preference associated with the desired edge portion.

In yet another embodiment, a number of icons displayed in the display area depends on a space allocated for the interface on the display device.

In a further embodiment, at least one edge portion of the first edge portion and the second portion, the interface causes the computing device to: associate a first score to a first end of the at least one edge portion, the first score representing the lowest degree of liking in the first edge portion or disliking in the second edge portion; associate a second score to a second end of the at least one edge portion, the second score representing the highest degree of liking in the first edge portion or disliking in the second edge portion; detect an intersection point between a dragging trajectory of the dragged icon and the at least one edge portion; modify the coefficient of the search result represented by the dragged icon in accordance with a position of the intersection point between the first end and the second of the at least one edge portion.

In an embodiment, the function is activated when the dragged icon is brought in contact with, or within a predetermined distance of the selected edge portion.

In another embodiment, the function is activated when the dragged icon is accelerated and released toward the destination edge portion, the interface causing the computing device to: measure a direction of movement of the dragged node to determine the destination edge; measure an acceleration of a dragging movement; and activate the function associated with the destination edge portion when the acceleration exceeds a predetermined threshold.

In an embodiment, when an icon is dragged toward a destination edge portion, the interface causes the computing device to: measure a direction of movement of the dragged icon to determine the destination edge portion; provide a visual indicator indicating the destination edge portion and the function associated therewith.

The interface may be personalized by associating the desired function and user preference to the desired edge portion.

The user preference may be one of: like, dislike, discard, ignore, buy, preview, and share.

The cons represent products comprising one or more of author, singer, dancer, music composer, band, actor, music album, song, painting, book, movie, game, electronic device, a property which describes the product, and a person's name or picture.

In another aspect, there is provided a graphical user interface (interface) on a computing device comprising a memory and a processor for executing computer instructions stored on the memory for implementing the interface in a web browser on a display device, the interface comprising: a display area for displaying search results returned in response to a search query; and an edge surrounding at least a portion of the display area, the edge having a function associated therewith, the function being activated when one or more keywords/links within the search results are dragged toward the edge; wherein when the function is activated, the interface performs a new search with a new search query based on the selected keywords and a user preference associated with the function.

In an embodiment, if the user preference indicates that the user likes the dragged keywords, the new search query comprises or consists of the selected keywords.

In another embodiment, if the user preference indicates that the user dislikes the dragged keywords, the new search excludes search results including the selected keywords.

In yet another aspect, there is provided a method for performing a product search on a computing device, the method comprising: receiving and storing a list of products returned by the search and a list of coefficients associated with the products; displaying products having the highest coefficients, as icons representative thereof, in a display area defined by an edge on a display device; associating a function indicating a user preference to the edge; detecting the dragging of an icon toward the edge; activating the function after the dragging; adjusting the coefficients of products related to the dragged product in accordance with the user preference associated with the edge; refining the icons displayed in the search interface based on the adjusted coefficients.

In an embodiment, the method further comprises displaying the icons in a cluster including a visual link between icons representing products having a common characteristic, and displaying the common characteristic in a tag associated with the visual link.

Features and advantages of the subject matter hereof will become more apparent in light of the following detailed description of selected embodiments, as illustrated in the accompanying figures. As will be realized, the subject matter disclosed and claimed is capable of modifications in various respects, all without departing from the scope of the claims. Accordingly, the drawings and the description are to be regarded as illustrative in nature, and not as restrictive and the full scope of the subject matter is set forth in the claims.

### BRIEF DESCRIPTION OF THE DRAWINGS

Further features and advantages of the present disclosure will become apparent from the following detailed description, taken in combination with the appended drawings, in which:

FIGS. 1a to 1c illustrate user interfaces with edges having different shapes, in accordance with an embodiment;

FIG. 2 illustrates an example of a user interface 200 having four edges 202 to 208 defining a rectangle;

FIG. 3 illustrates an exemplary user interface illustrating a cluster of search results presented as icons with visual links between related results;

FIG. 4 illustrates an example of a queue corresponding to the interface of FIG. 3 for storing the search results;

FIGS. 5a to 5e illustrate the steps of updating the cluster of search results displayed in the search interface when a search result is liked;

FIG. 6 illustrates an updated version of the queue of FIG. 4, corresponding to the interface of FIGS. 5b to 5e;

FIGS. 7a to 7f illustrate the steps of updating the cluster of search results displayed in the search interface when a tag is liked;

FIG. 8 illustrates the queue corresponding to the interface of FIG. 7a;

FIG. 9 illustrates the top artists associated with the tag selected in FIG. 7b;

FIG. 10 illustrates an updated version of the queue of FIG. 8, corresponding to the interface of FIGS. 7b to 7e;

FIG. 11 illustrates an example of a search interface which allows the user to throw a selected item toward a desired edge, in accordance with an embodiment;

FIG. 12 illustrates an example of a search interface in which different functions are associated to different portions of the same edge, in accordance with an embodiment;

FIG. 13 illustrates an example of an interface with graded edges, in accordance with an embodiment;

FIGS. 14a-14i illustrate an exemplary implementation of an interface that allows the user to view and manipulate the specification sheet of a product, in accordance with an embodiment;

FIGS. 15a-15d illustrate an exemplary implementation of an interface that allows the user to like/dislike keywords and phrases within the search results, in accordance with an embodiment;

FIG. 16 is a flowchart of a method for performing a product search on a computing device; and

FIG. 17 illustrates an embodiment of a computing environment in which embodiments of the present invention may be practiced.

It will be noted that throughout the appended drawings, like features are identified by like reference numerals.

### DETAILED DESCRIPTION OF THE PREFERRED EMBODIMENTS

The present document describes a graphical user interface (GUI) for displaying and refining search results. The search results are received and stored in a queue along with a coefficient of relevance associated with each search result. The search results with the highest coefficients are displayed within the edge. A function indicating a user preference (like, dislike, etc.) is associated with the edge of the GUI, whereby when the user drags a search result toward the edge, the coefficients of the related search results are modified in accordance with a similarity factor between the dragged search result and the related search results. For example, if the user preference associated with the edge indicates that the user likes the dragged search result, the interface would increase the coefficient of the related search results and refine the search results displayed within the edge of the interface based on the modified coefficients.

In embodiments there is disclosed a user interface for searching and viewing products in a user friendly manner. A user interface in accordance with the present embodiments saves the user the trouble of typing new search queries and moving back and forth through the different search result pages to refine the search. In addition to being user friendly, such interface is ideal for implementation on smart phones and portable devices with limited screen sizes.

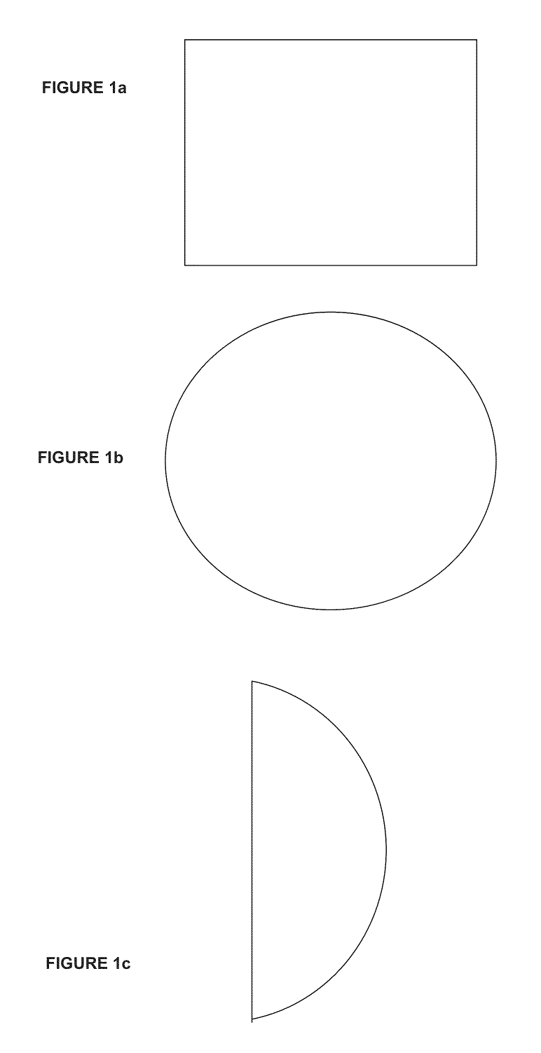

The user interface is displayed on a display area of a display device (e.g. screen, monitor etc.). The interface defines a periphery surrounding the display area. The periphery may have edges with different shapes as shown in FIGS. 1a to 1c. The edge may be provided near or at the periphery. The periphery may have one edge or a plurality of edges. Preferably, the user interface would have a rectangular edge with four edge portions (hereinafter four edges) as shown in FIG. 1a to use the maximum space possible since most displays/monitors have a rectangular shape. However, nothing prevents from implementing the user interface as a circle, ellipse, arc, etc. as exemplified in FIGS. 1b and 1c.

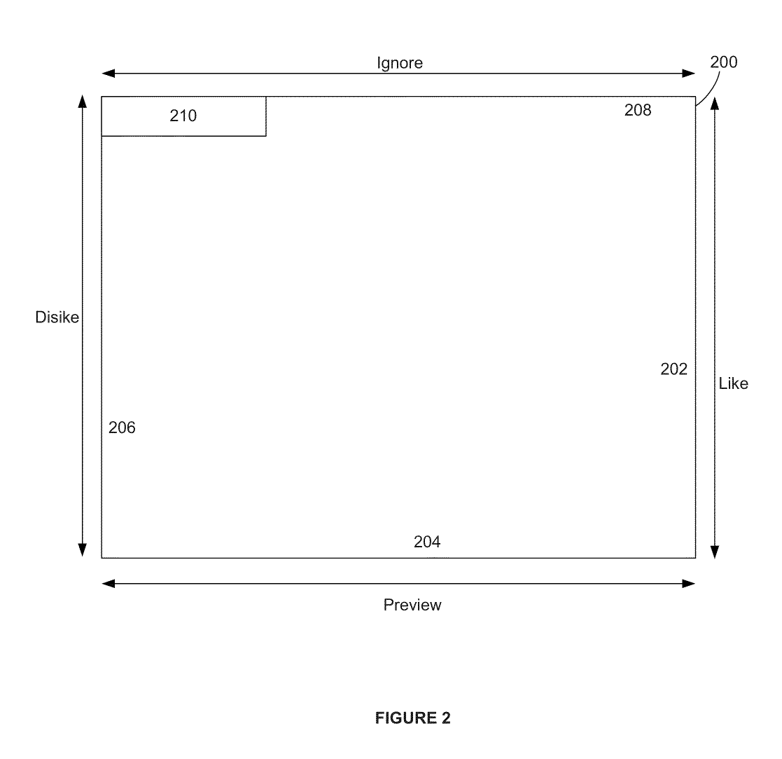

FIG. 2 illustrates an example of a user interface 200 having four edges 202 to 208 defining a rectangle. The interface 200 may include a search query region 210 for typing the search query in. The search query region may be provided within the edges of the interface 200 and may also be provided outside the interface 210. It is also possible that the search query region 210 appears and disappears when touching a certain location on the screen/keyboard. The user may type in a search query and hit search. The search results may appear within the edges of the interface 200.

In an embodiment, a function indicating a user preference is assigned to at least one edge (or portion of an edge) of the user interface. For example, as shown in FIG. 2, edge 202 is assigned the function “like”, edge 204 is assigned the function “preview”, edge 206 is assigned the function “dislike”, and edge 208 is assigned the function “ignore”. Whereby, the user may drag a search results toward one of the edges 202 to 208 of the interface 200 to activate the function associated with that edge. Prior to activating the function, the interface may provide a visual indicator indicating the edge toward which the user is moving the search result and the function associated with that edge. The function may be activated by bringing the search result in proximity or in contact with the edge, or by throwing the function toward the edge as will be described in further detail hereinbelow.

An interface in accordance with the present embodiments may be used for performing different types of searches. For example, it may be used for performing a product search, or a regular search in a web browser using the internet or the like or local search of a local database/library. Examples of products may include: artist, author, singer, dancer, music composer, music type, band, actor, music album, song, painting, book, movie, game, electronic device etc.

In an embodiment, after receiving a search query command the interface (or the processor of the computing device on which the interface is implemented) may return a number of search results each having associated therewith: a coefficient of relevance (hereinafter coefficient), a list of similar results/products, a factor of similarity between the result and each similar product, and one or more common characteristics that relates the result to the similar product. The interface stores the results and the associated data in a queue in memory. In an embodiment, the results may be ordered in the queue in accordance with the magnitude of the coefficients associated therewith, so that the results having the highest coefficients are stored at the beginning of the queue and displayed first and those having lower coefficients are stored at the end of the queue and displayed last (if they are ever displayed). The interface may display a number (or all) of the results stored in the queue based on the space allocated to the interface 200 on the display. The products may be displayed as icons or nodes.

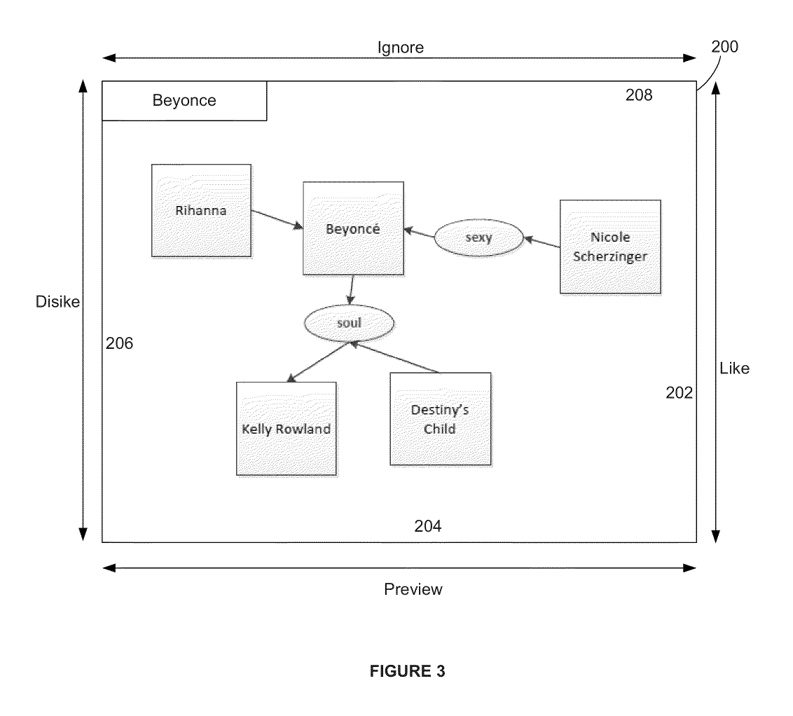

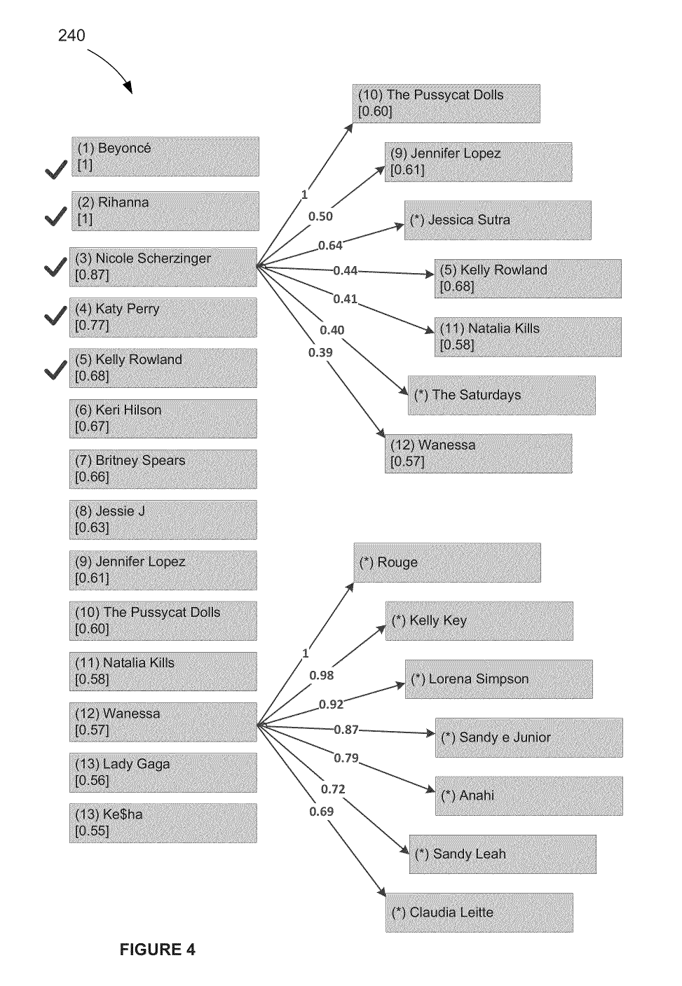

In an embodiment, the interface may display the search results within the edges thereof while showing a visual link between two (or more) of the results based on a common characteristic that exists between the two results. FIG. 3 illustrates an exemplary user interface illustrating a cluster of search results presented as icons with visual links between related results. The common characteristic may be a characteristic that relates to the search result such as type of music, character of the actor etc. and may also relate to the user's social network. For example, the common characteristic could be the fact that the user's friends recommend the product or have bought it, or they like it (or dislike it), or wrote a review about it etc. As shown in FIG. 3, the interface 200 may associate a tag to the visual link to indicate the common characteristic that exists between the search results linked by the visual link. With reference to FIG. 3, assuming that the user wants to search the music of the singer ‘Beyoncé’, the user may type the name of the singer in the search query region 210 and hit search. As shown in FIG. 3, the interface 200 returns and displays a number of singers and provides a visual link between related singers. For example, Beyoncé and Nicle Scherzinger are related by being ‘sexy’, while Kelly Rowland and Beyoncé are related by the type of music ‘soul’ that they sing.

FIG. 4 illustrates an example of a queue 240 illustrating a number of search results listed in the order of the magnitude of their coefficients. For instance, the singers Beyoncé and Rihanna have a coefficient of 1 (which is the highest) and take the first two places in the queue 240 since they both have many characteristics in common; Nicole Scherzinger has a coefficient 0.87 and comes in the third place and so on. FIG. 4 also shows the singers that are similar to Nicole Scherzinger along with a factor of similarity. Each singer listed in the list has a list of related singers, however for space constaints, FIG. 4 shows only the lists associated with Nicole Scherzinger and Wanessa.

### Dragging an Icon

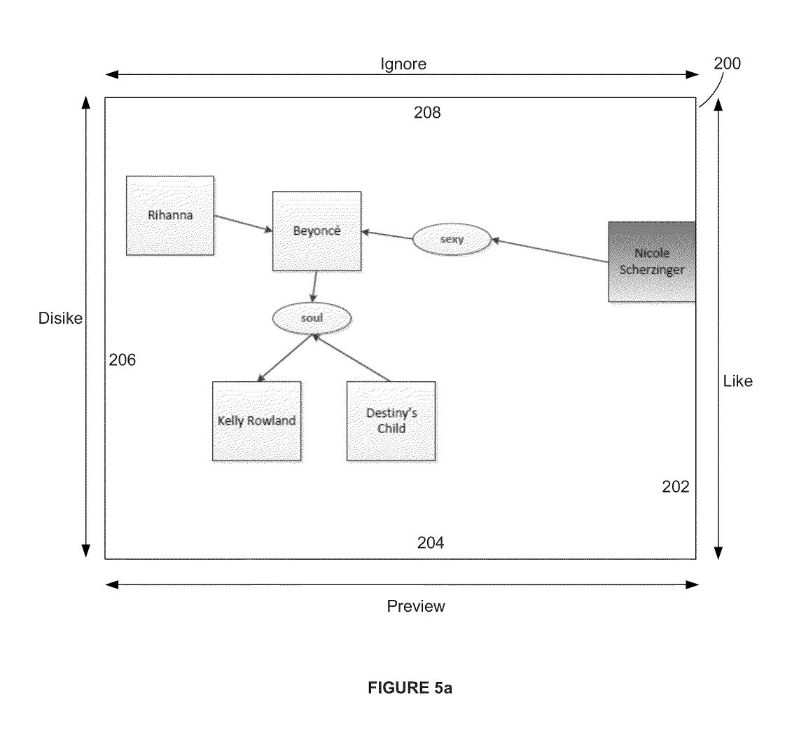

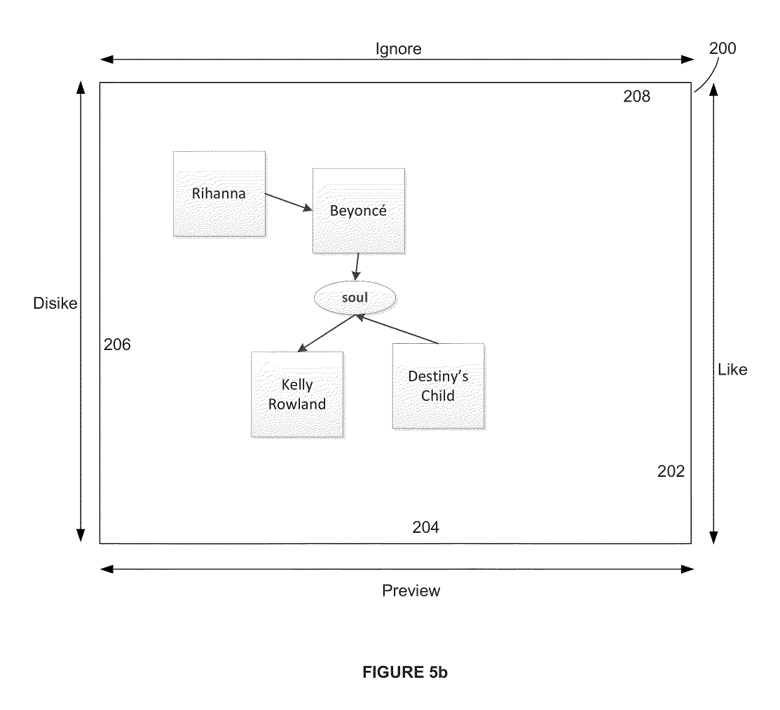

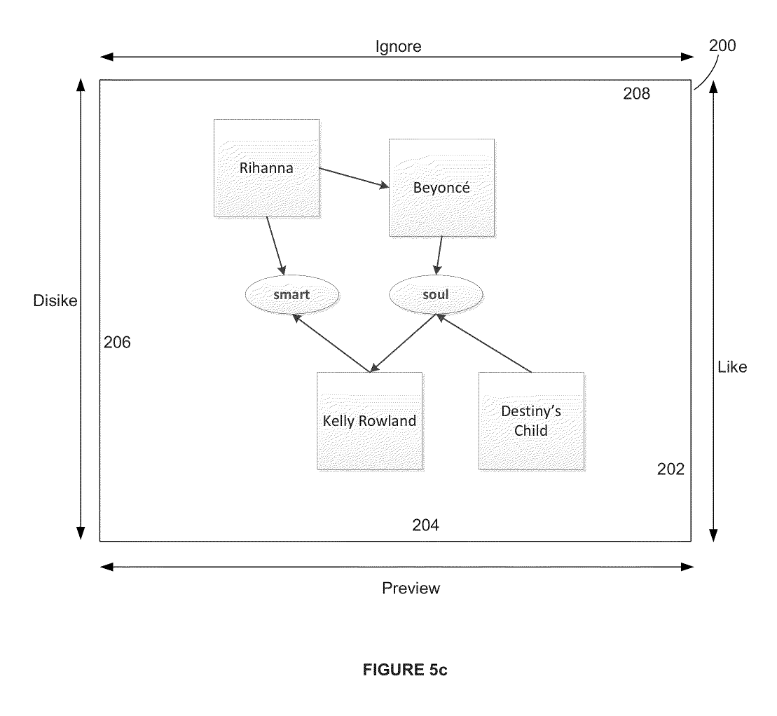

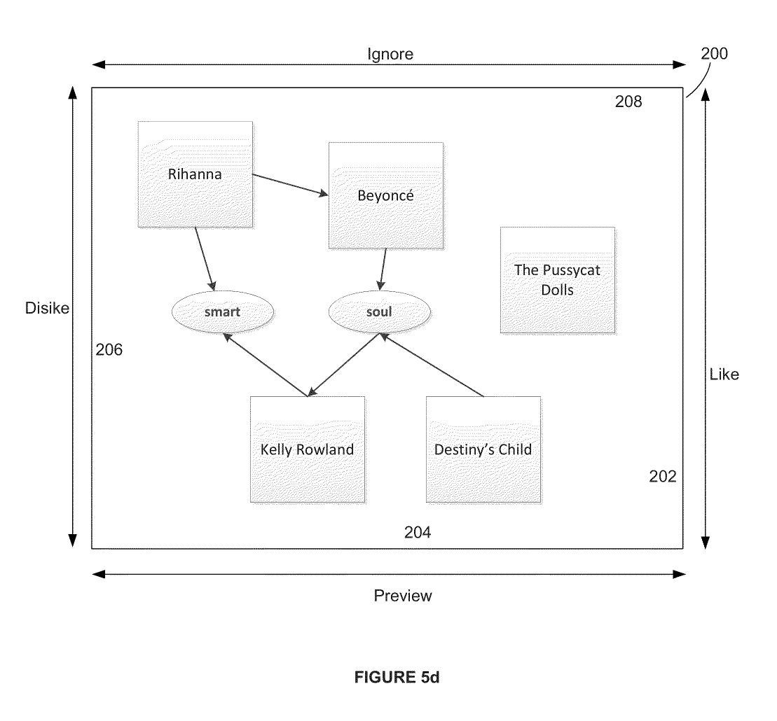

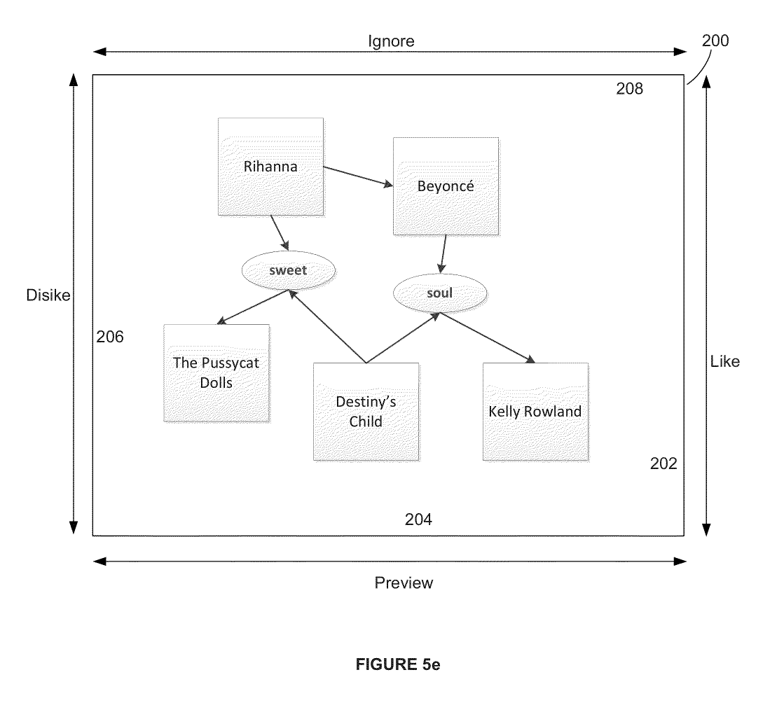

As discussed above with reference to FIG. 2, one or more of the interface edges may have a function associated with them. Accordingly, if the user drags an icon toward one of these edges and activates the function associated with that edge, the interface would refine the search results displayed within the interface or play a sample of the product represented by the dragged icon. For instance, if the user drags an icon toward the like edge 242 the interface 200 may remove the dragged icon from the display, adjust the coefficient of similarity of that icon to be the highest, and then adjust the coefficient of the similar products in the queue. Adjusting the coefficient of the similar results may be based on the similarity factor between these results e.g. 0.5 between Nicole Scherzinger and Jennifer Lopez as shown in FIG. 4. The queue may then reordered to take into consideration the new coefficients, and a new result may be displayed in the interface along with a new link and a new tag. An example is illustrated in FIGS. 5a to 5e.

Assuming that the user likes Nicole Sherzinger, they may drag the icon representing her toward the like edge 202, as shown in FIG. 5a. The interface would then remove the icon of Nicole Scherzinger from the cluster, as shown in FIG. 5b, and recalculates the links as shown in FIG. 5c. In the meantime, the interface may increase the coefficient of Nicole Scherzinger to 1, and adjust the coefficient of the related singers based on the factor of similarity. In the present example, re-adjustment of the coefficient is done by adding the factor of similarity of to the coefficient of the related singer and dividing the sum by two. In another embodiment, it is possible to determine an amount to be added and multiply that amount by the factor of similarity and add the result to the coefficient of the similar result. Other methods may also be used to adjust the coefficients.

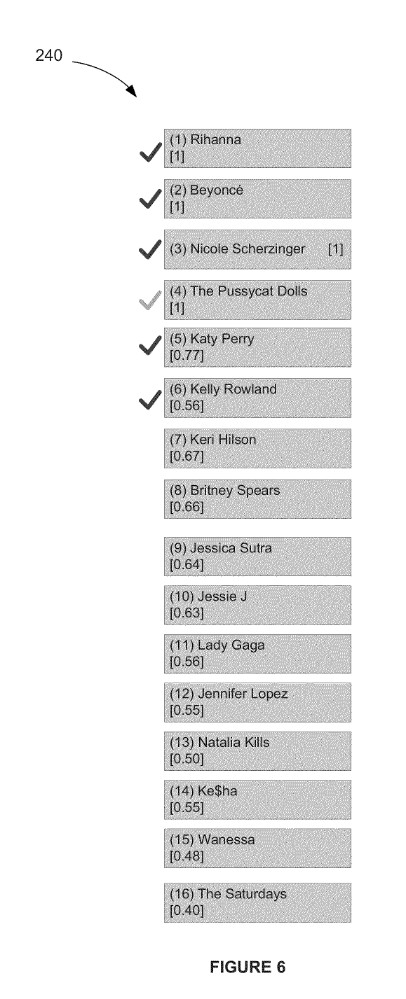

The queue 240 is reordered to take into account the new coefficients, as shown in FIG. 6. Of course the liked singer (result) would remain in the queue but would not appear in the interface unless the user does so manually for example by touching or double-clicking on the liking edge to bring the liked results back into the cluster to be displayed. Once the queue 240 is reordered, a new singer (The Pussy Cat Dolls) is displayed in the interface 200 as shown in FIG. 5d, and new links/tags (sweet) may be calculated and displayed as illustrated in FIG. 5e.

It should be noted that it is not mandatory to display the steps of each of FIGS. 5a to 5e to the user, but this method may be useful to indicate the progress while the system is calculating the results and/or updating the queue.

In an embodiment, the common characteristics may also be stored in accordance with their relevance. In the example of FIG. 5d, the ‘smart’ tag between Rihanna and Kelly Rowland has been removed for including a ‘sweet’ tag that relates Rihanna, The Pussy Cat Dolls and Destiny's Child.

In an embodiment, the user may dislike one of the results by dragging the corresponding icon toward the dislike edge 246. The interface would then remove the dragged product from the cluster, decrease the coefficient of the dragged product and the coefficient of the related products based on the factor of similarity. This step may be performed in the same manner as the step of liking with the exception that the coefficients are decreased.

In an embodiment, the user may preview a product (when applicable) in the search result by dragging the icon representing that product toward the preview edge 244. The interface would then select the appropriate computer program to play a sample of the product. For example, the user may listen to previews of songs of a certain singer or composer or album. They may also see samples of a video starring a certain actor, or illustrate a sample of a painting for a certain artist or a page of a book of a certain author etc.

In an embodiment, the user may ignore a certain search result by dragging the icon representing that result toward an ignore/discard edge 248. In this case the interface would remove the dragged result from the cluster without changing its coefficient or the coefficients of the related results.

The user may always press or click on one of the edges to see the search results added to that edge and/or undue one of the actions e.g. return an item from the like edge to the search interface to be displayed. The interface would then undo the function associated with the edge by re-adjusting the coefficients, reordering the queue and the cluster of search results displayed within the interface etc.

### Dragging a Tag

In a further embodiment, the user may perform the actions described in FIGS. 5 and 6 with a tag rather than an icon.

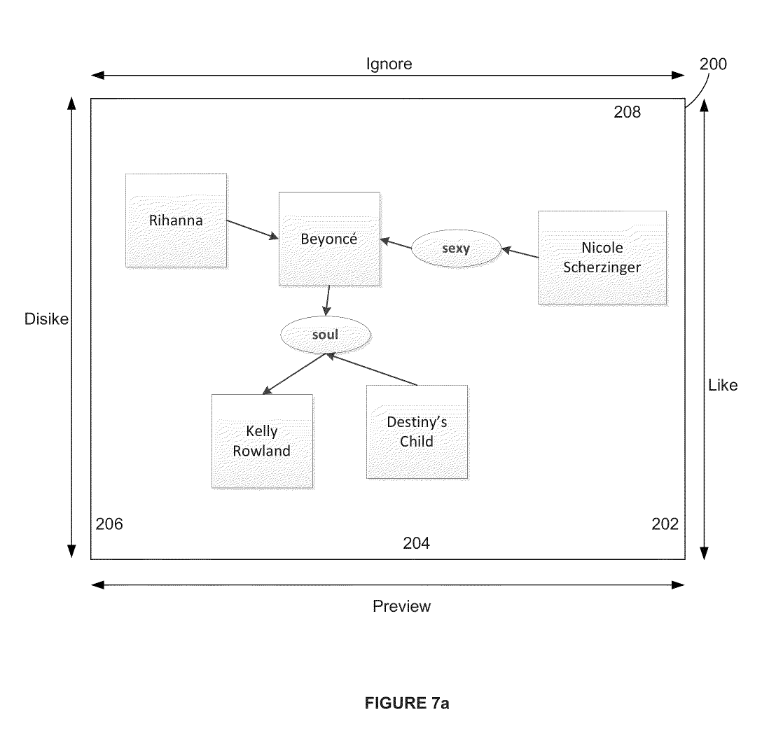

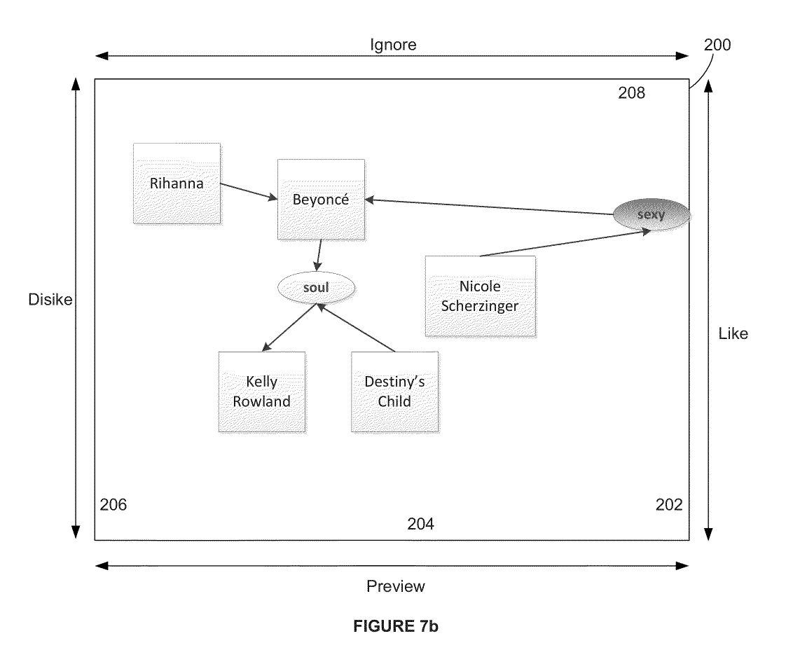

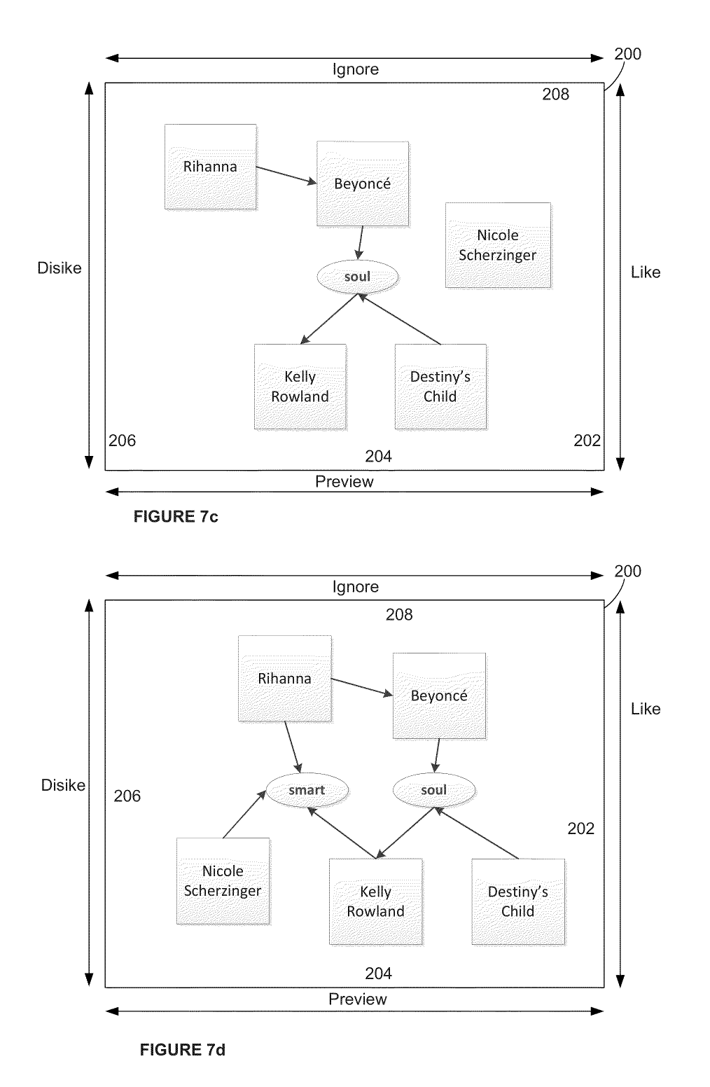

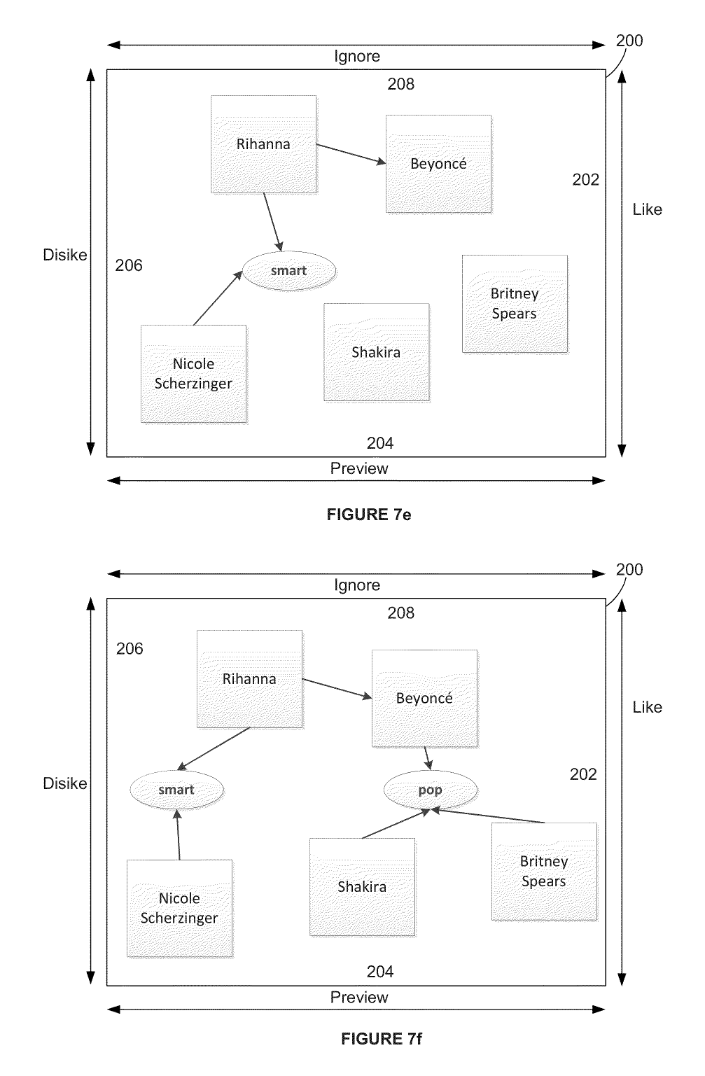

For example, when the user drags a tag toward the like edge 202, the tag's top results are fetched to increase their coefficients and/or add them to the queue where applicable. The queue is then reordered to take into account the new coefficients associated to the results. On the interface level, the tag that is dragged disappears from the interface to be replaced by one or more other tags, and the cluster of search results may also be modified to take into consideration the new coefficients. An example is illustrated in FIGS. 7a to 7f.

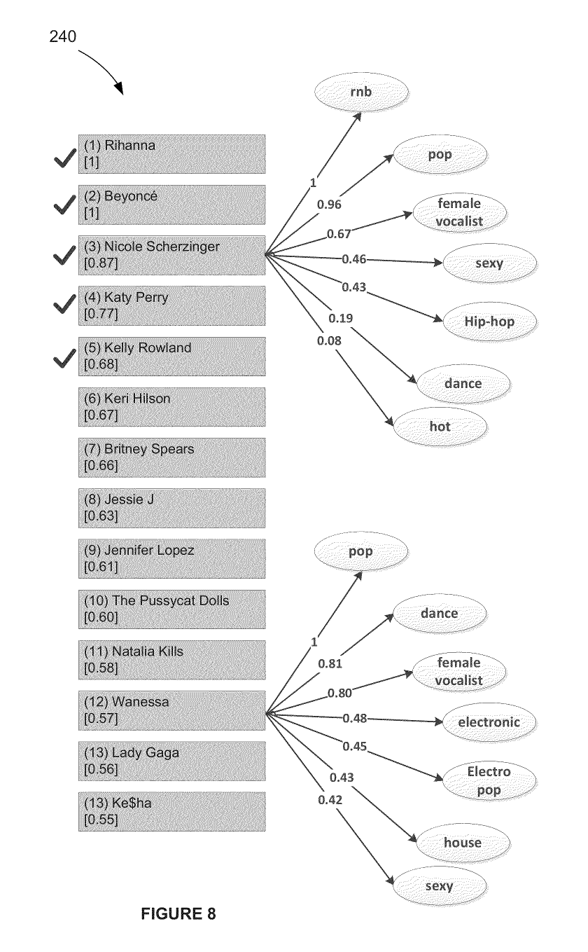

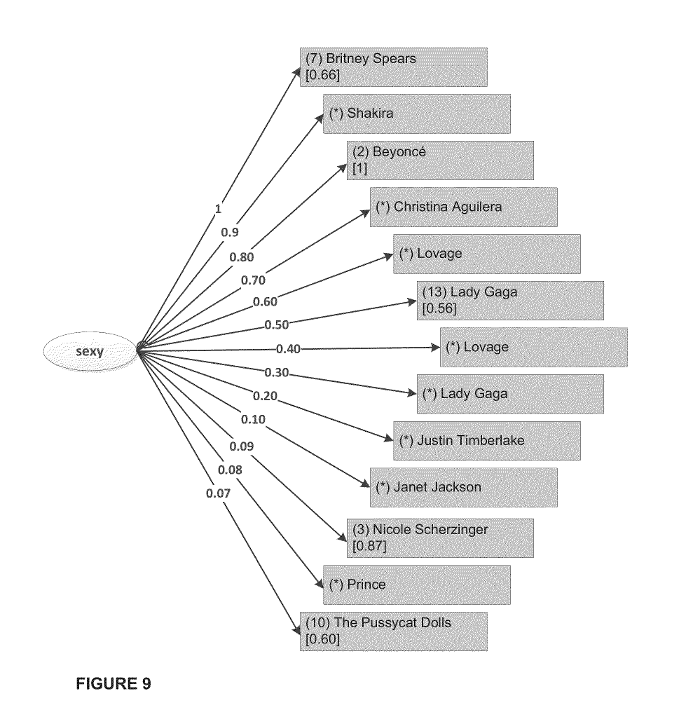

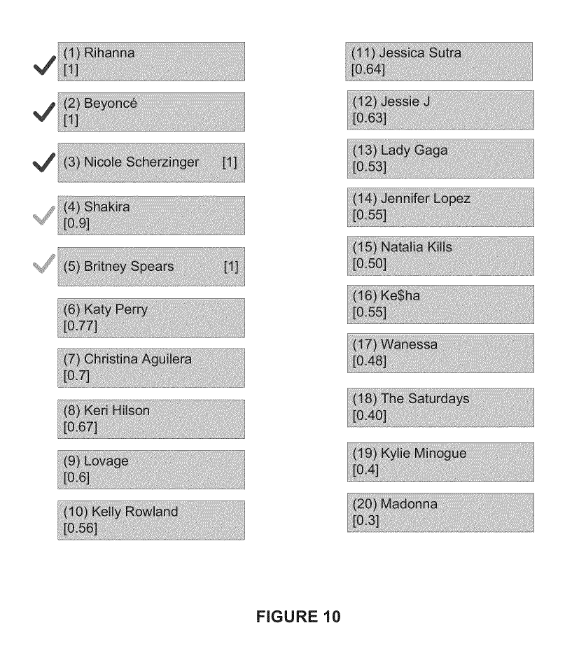

FIG. 7a illustrates an exemplary user interface including a cluster of icons representing search results and tagged visual links between related results. FIG. 8 illustrates the queue corresponding to the interface of FIG. 7a. If the user likes singers that are ‘sexy’ they may drag the tag ‘sexy’ toward the liking edge 202, as shown in FIG. 7b. When the tag is liked, the tag may be removed from the interface as shown in FIG. 7c, and the tag's top artists are fetched as shown in FIG. 9 to increase their coefficients. After the tag is removed other tags are displayed as shown in FIG. 7d. Once the coefficients are modified the queue may be reordered to take into account the new coefficients, as shown in FIG. 10. Once the queue is reordered, the cluster of products shown in the interface 200 is changed. For example, since Shakira and Britney Spears became in the top five places in the queue as shown in FIG. 10, the interface would display them instead of Kelly Rowland and Destiny's Child, as shown in FIG. 7e. New tags may then be calculated between the related icons as shown in FIG. 7f which shows that Briteny Spears, Beyoncé and Shakira are linked by the tag ‘pop’ which indicated that the three singers sing pop music.

The other functions (dislike, ignore, preview, etc.) may also be applied by dragging the tag toward the desired edge or portion of an edge. These functions have been discussed above in connection with the dragging of icons representing search results and will not be repeated herein.

### Throwing Icons and Tags

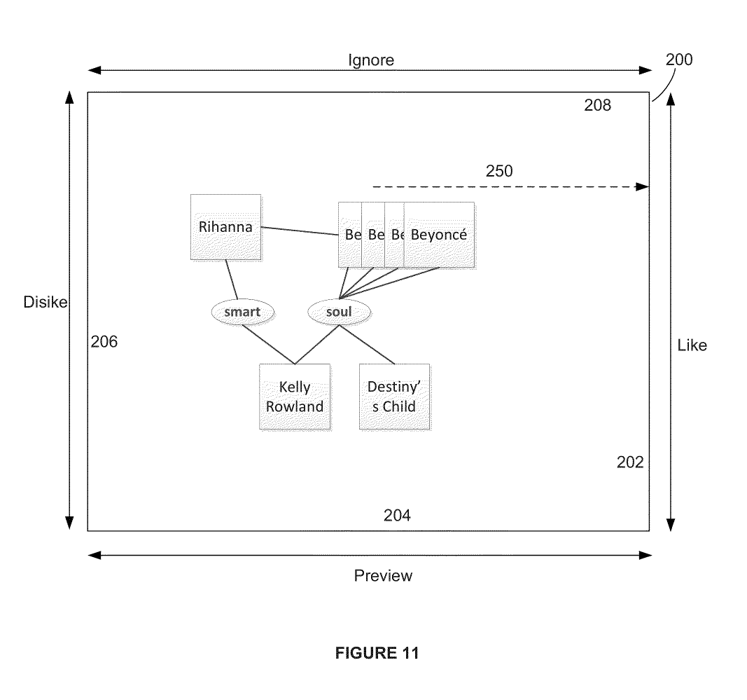

Activation of the function associated with a certain edge may be done in a variety of different ways. In one examples above, the user drags the selected item (icon, tag, search result, etc.) toward the desired edge to activate the function when the dragged item comes in contact with the desired edge, or when the dragged item becomes within a predetermined distance of that edge. In another embodiment, the user may activate the function by throwing the desired item toward the desired edge. For example, instead of dragging the desired item all the way to the edge, the user may drag the item in the direction of the desired edge, accelerate the dragging and then releases the dragged item. The interface calculates the destination edge (or portion of an edge) based upon the direction of movement of the dragged item. An example is illustrated in FIG. 11.

FIG. 11 illustrates an example of a search interface which allows the user to throw a selected item toward a desired edge, in accordance with an embodiment. In the example of FIG. 11, the user drags the icon “Beyoncé” toward the like edge 202. Based upon the direction of the movement, the interface may project that the destination edge is the “like” edge 242, as indicated by arrow 250. The interface may display a visual indication to alert the user of the destination edge. For example, the interface may highlight the “like” edge 242 and the function associated with it e.g. display a heart or the like etc.

If the user accelerates the dragging movement and releases the dragged item, the dragged item may be added to the “Like” folder and the results displayed within the search interface may be modified as discussed above.

As discussed above, the user may press or click on one of the edges to see the search results added to that edge and/or undue one of the actions e.g. return an item from the like edge to the search interface to be displayed.

### Dividing the Edges

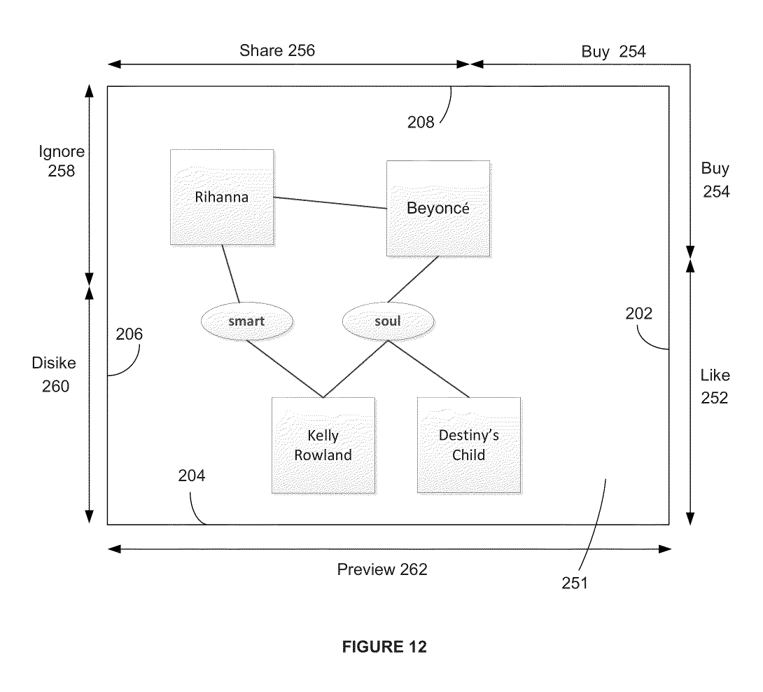

The embodiments discussed above describe the possibility of associating one function to one edge portion. However, it is also possible to associate one function to the entire edge defining the interface or a portion of the edge portion, whereby the edge portion may have different sub-portions having different functions. An example is illustrated in FIG. 12.

FIG. 12 illustrates an example of a search interface 251 in which different functions are associated to different sub-portions of the same edge, in accordance with an embodiment. As shown in FIG. 12, the interface 251 includes four edge portions 202, 204, 206, and 208. In the present example, edge portion 202 is divided into two portions a “like” portion 252 and a “buy” portion 254. Edge portion 208 includes a “buy” portion 254 which is shared with edge 202 and a “share portion” 256. Similar to the other edge portionss, edge portion 206 is divided into an “ignore” portion 258 and a “dislike” portion 260. Edge portion 204 may be reserved for the “preview” function as in the other embodiments.

If the user drags an item toward the “buy” portion 254 the item may be added to the cart for later or immediate checkout. If the user wants to share the item they may drag it to share portion 256. The interface may display the logo of one or more social media networks e.g. Facebook, LinkedIn, Myspace etc. allowing the user to select one or more of these social networks for sharing the item on. When the user makes a selection of a social network, the interface may log into the user's account with the selected social network(s) and post the item (or sample thereof, or link, or preview/summary of the item) on the user's profile.

### Graded Edges

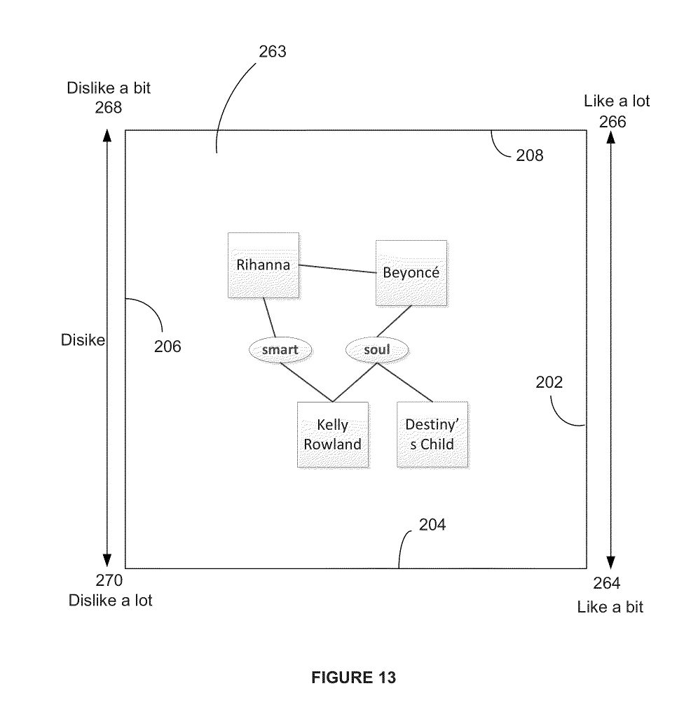

In an embodiment, the edge or portion of an edge is graded to give a score to each end of the edge. For example, it is possible to assign the lowest score to one end and the highest score to the opposite end. With reference to FIG. 13, the “like” edge 202 has two ends 264 and 266. The first end 264 is assigned the lowest liking score whereas the second end 266 is assigned the highest liking score. Whereby, the coefficient of the dragged item is adjusted based on the location of intersection between the first score and the second score. For example, if the selected item is dragged beside the first end 264 the coefficient of the dragged item would be increased by the minimum possible value, and if the selected item is dragged beside the second end 266 the coefficient of the item is increased to the maximum. Similarly, with the dislike edge 206. If the user drags an item beside the first end 270 the coefficient of that item would be decreased to the maximum, whereas it the item is dragged beside the second end 268 the coefficient of the dragged item would be decreased by a minimal value.

In the present embodiments, the dragged items may and may not be removed from the interface based on whether the like/dislike function effects a coefficient change that causes a reordering of the queue or not.

### Specification Sheet

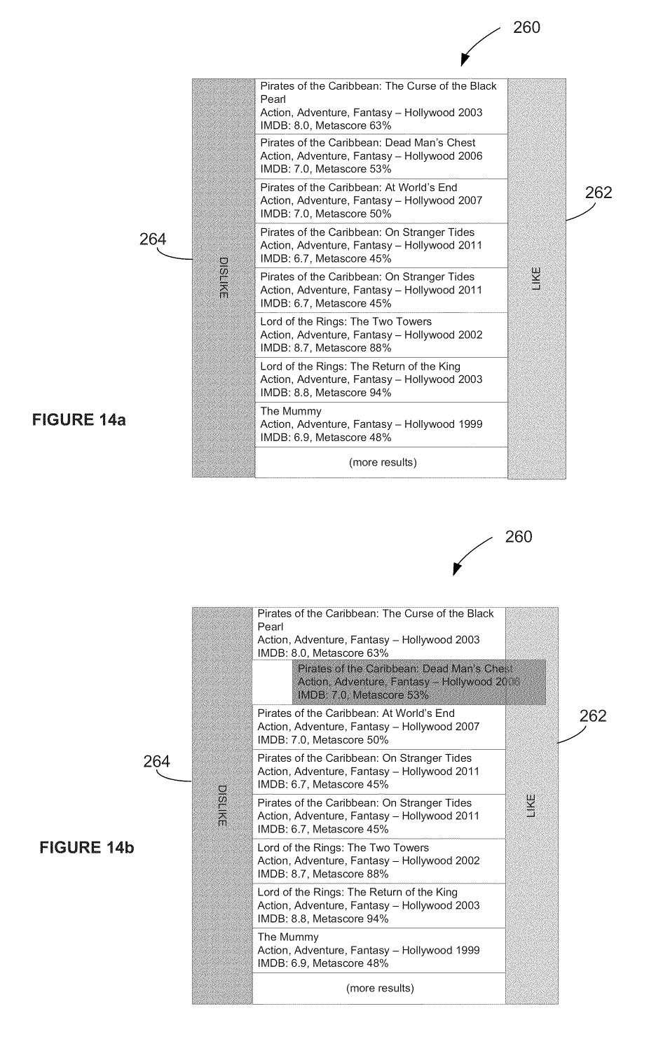

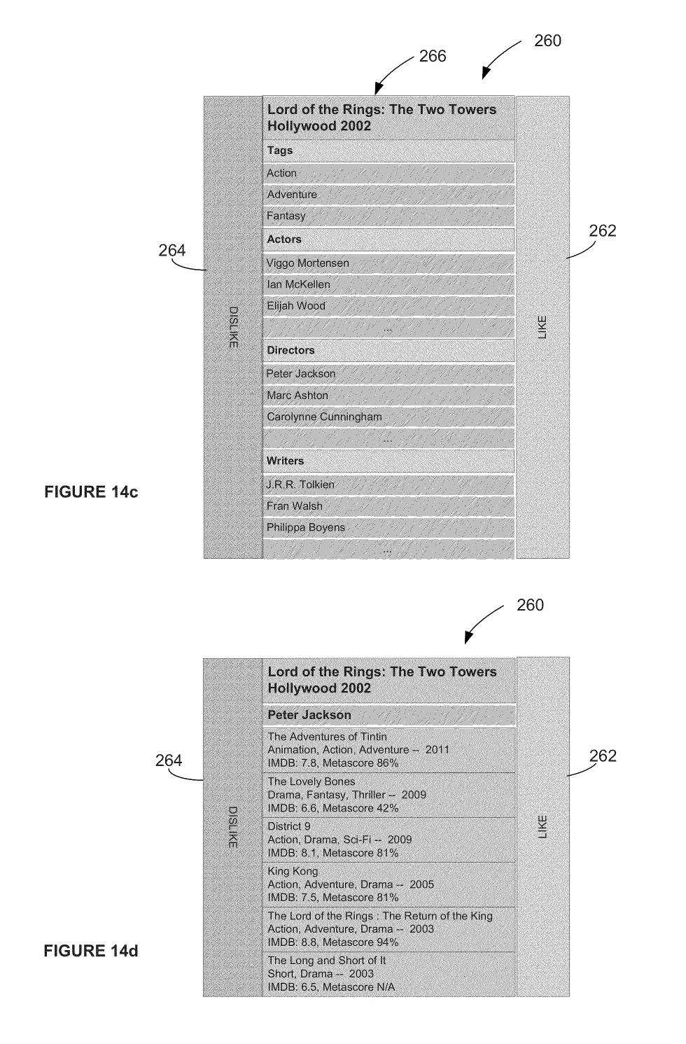

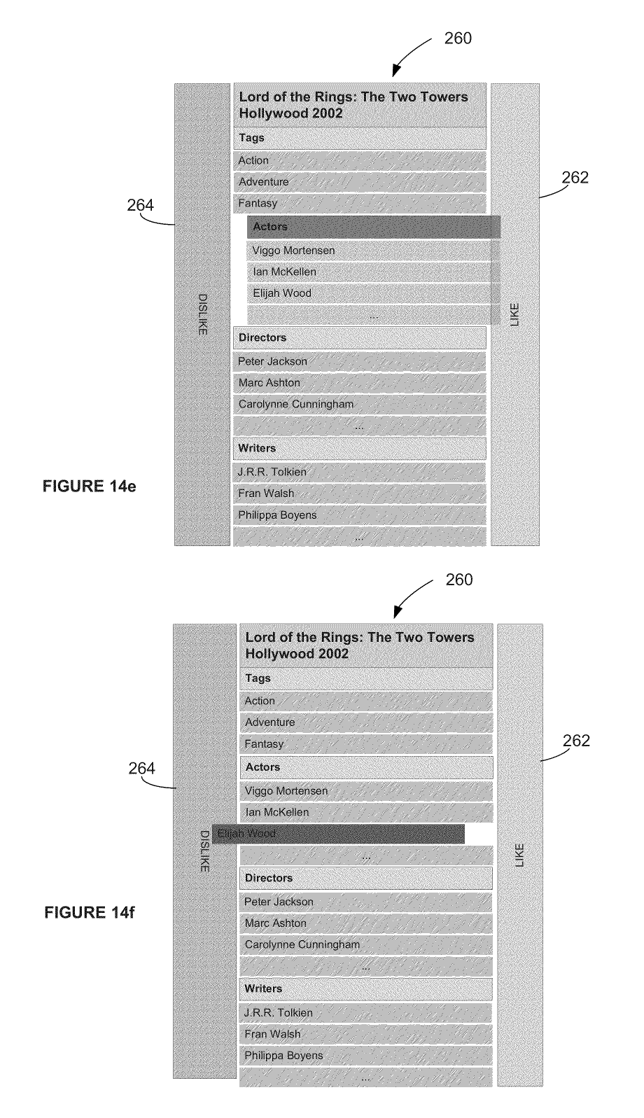

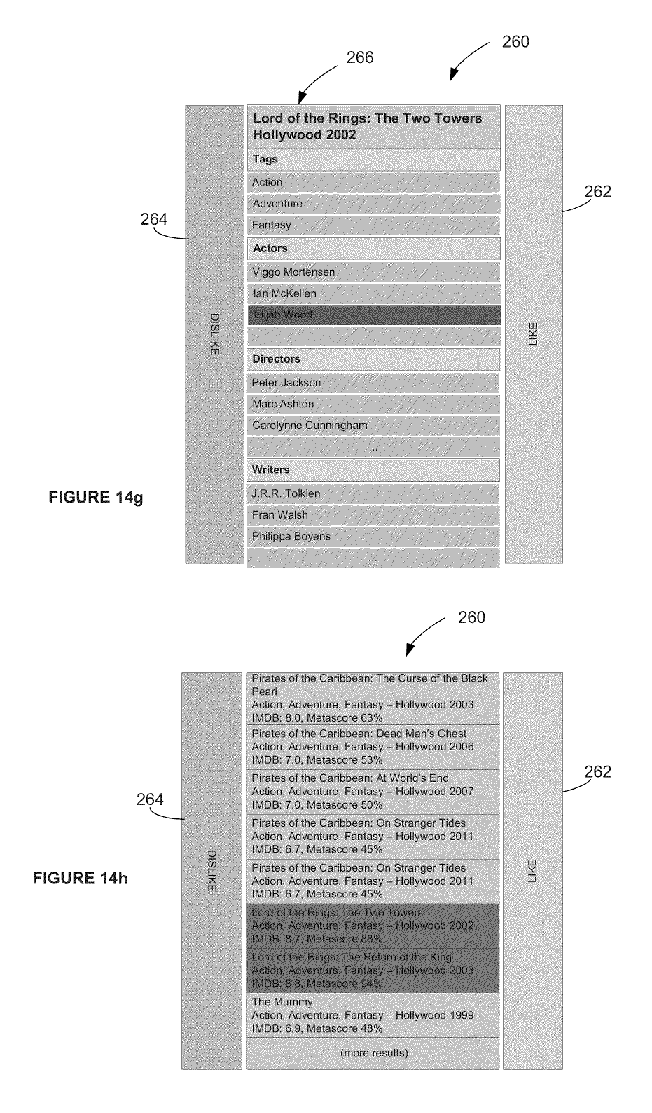

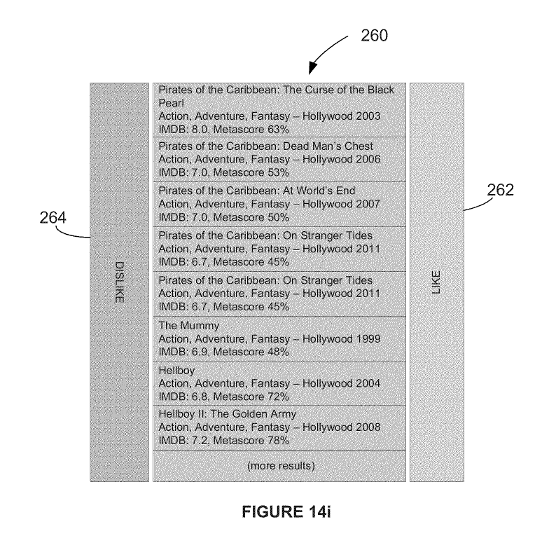

In an embodiment, the interface may allow the user to view and manipulate the specification sheet of a product. By manipulating the specification sheet the user may like or dislike certain characteristics in the specification sheet to refine the search. An example is provided in FIGS. 14a-14i. In the example of FIG. 14a, the product is a movie. However, the interface may be used with any product that has a specification sheet e.g. electronic devices, home appliances, cars, etc. FIG. 14a illustrates an exemplary implementation of an interface that allows the user to view and manipulate the specification sheet of a product.

The interface 260 shown in FIG. 14a illustrates the search results of the movie name “pirates of the Caribbean”. In the present example, the interface 260 comprises a first edge 262 defining a “like” edge, a second edge 264 defining a “dislike” edge, and a plurality of search results between the two edges 262 and 264. The search results may be provided in a list, as shown in FIG. 14a. If the user likes the movie “Pirates of the Caribbean—The dead Man's Chest”, they may drag this item toward the like edge 262 as shown in FIG. 14b. In an embodiment, the edges may have different colors and the dragged item may take the color of the destination edge while it is being dragged, as illustrated in FIG. 14b.

The user may also press/tap or click on one of the search results to view the specification of the product represented by the search result. As shown in FIG. 14c, if the user wants to see the specification sheet of the movie “Lord of the Rings: The Two Towers”, they may tap that search result and view the specification sheet 266 shown in FIG. 14c. The user may manipulate the specification sheet 266 by liking or disliking certain characteristics of the specification sheet 266, or by using certain characteristics within the specification as search criterion.

For example, referring back to FIG. 14c, the user may use the characteristics of the specification sheet as search queries. For example, the user may tap or double click on the director “Peter Jackson” to view the list of movies of this director, as shown in FIG. 14d. In another example, the user may like the actors (as a whole or selected ones), as shown in FIG. 14e.

In another embodiment, the user may dislike one of the characteristics. For example, the user may dislike one of the actors as shown in FIG. 14f. In an embodiment, the interface may keep the disliked characteristic in the list and provide a visual indication to indicate that this characteristic is disliked e.g. highlight the disliked characteristic with the same color as the dislike edge 264. The user may close the specification sheet 266 of the movie after viewing and/or liking/disliking certain characteristics within the specification sheet of the movie to return to the main search page. As in the previous embodiments, liking and disliking search results or characteristics associated with the search results would result in a change of coefficients in the search result queue.

In one embodiment, returning to the main search result page may be done by tapping or double clicking on the search result link. In the main search page, the interface may detect the items having the common disliked (or liked) characteristics and provide them with a visual indication as shown in FIG. 14h. The visual indication and the search results having the disliked characteristic may be displayed for few seconds and then they may disappear from the interface to display more relevant results based on the new coefficients in the queue, as shown in FIG. 14i where the movies “Lord of the Rings: The Return of the King”, and “Lord of the Rings: The Two Towers” have been removed and replaced by the movies Hellboy I and II.

### Liking Keywords and Links

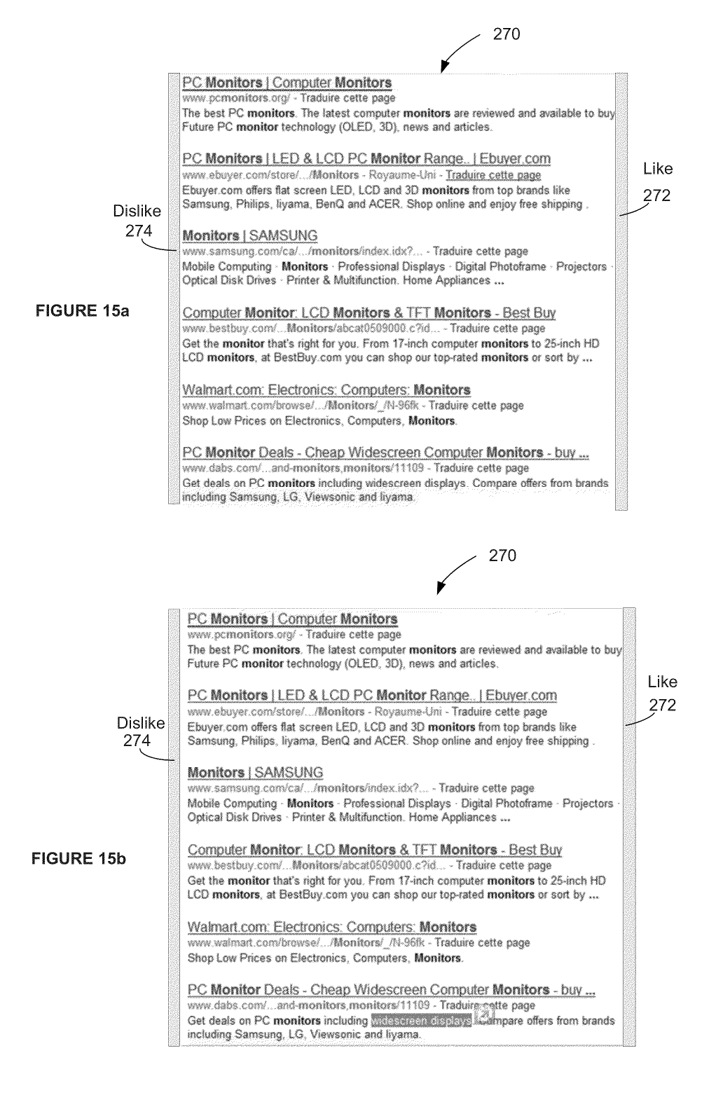

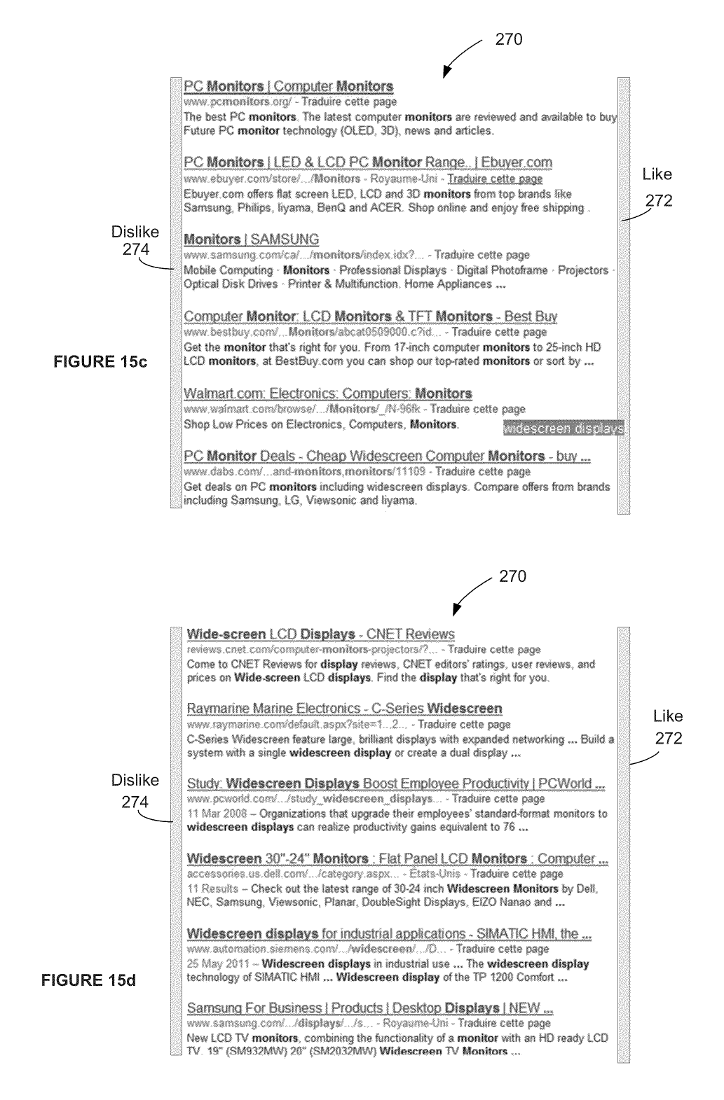

In a further embodiment, the interface may be implemented in a web browser to perform searches using a search engine such as Google, Yahoo, MSN etc, whereby the interface allows the user to refine and filter the search by liking/disliking (as well as the other functions) keywords, phrases, terms, etc. in the search results by dragging the selected keywords toward a desired edge. An example is provided in FIGS. 15a-15d.

FIGS. 15a-15d illustrate an exemplary implementation of an interface that allows the user to like/dislike keywords and phrases within the search results, in accordance with an embodiment. As shown in FIG. 15a the interfaces 270 comprises an edge 272 defining a “like” edge, and an edge 274 defining a “dislike” edge. The interface 270 shown in FIG. 15a illustrates the search results of the search query “monitor” using the Google search engine. If the user is interested in one of the keywords, terms, phrases in the search results they may select these keywords from the search result page as shown in FIG. 15b where the user selected the words “widescreen displays” and drag them toward the desired edge as illustrated in FIG. 15c. The interface 270 may then prompt another search for the liked keywords “widescreen displays”, as illustrated in FIG. 15d. In another embodiment, the interface 270 may replace the search query initially entered with the selected words and initiate a new search for the selected words. In another embodiment, the search interface 270 may add the selected keywords to the search query.

If on the other hand, the user dislikes some keywords, the interface 270 may refine the search to exclude (or lower the coefficient of) search results which include the disliked words.

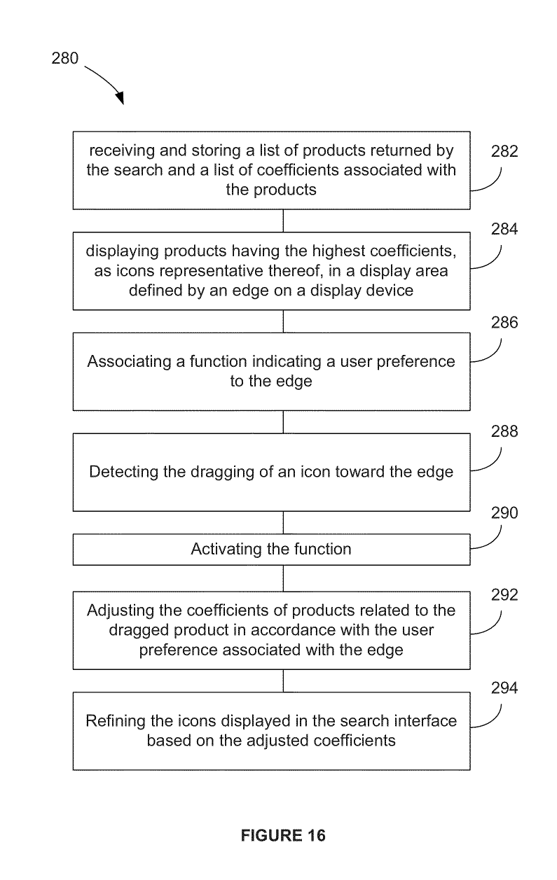

FIG. 16 is a flowchart of a method 280 for performing a product search on a computing device. The method begins at step 282 by receiving and storing a list of products returned by the search and a list of coefficients associated with the products. Step 284 comprises displaying products having the highest coefficients, as icons representative thereof, in a display area defined by an edge on a display device. Step 286 comprises associating a function indicating a user preference to the edge. Step 288 comprises detecting the dragging of an icon toward the edge. Step 290 comprises activating the function. Step 292 comprises adjusting the coefficients of products related to the dragged product in accordance with the user preference associated with the edge. Step 294 comprises refining the icons displayed in the search interface based on the adjusted coefficients.

### Hardware and Operating Environment

Embodiments of the invention may be implemented/operated using a client machine.

The client machine can be embodied in any one of the following computing devices: a computing workstation; a desktop computer; a tablet, a laptop or notebook computer; a server; a handheld computer; a mobile telephone; a portable telecommunication device; a media playing device; a gaming system; a mobile computing device; a device of the IPOD or IPAD family of devices manufactured by Apple Computer; any one of the PLAYSTATION family of devices manufactured by the Sony Corporation; any one of the Nintendo family of devices manufactured by Nintendo Co; any one of the XBOX family of devices manufactured by the Microsoft Corporation; or any other type and/or form of computing, telecommunications or media device that is capable of communication and that has sufficient processor power and memory capacity to perform the methods and systems described herein. In other embodiments the client machine can be a mobile device such as any one of the following mobile devices: a JAVA-enabled cellular telephone or personal digital assistant (PDA), such as the i55sr, i58sr, i85s, i88s, i90c, i95cl, or the im1100, all of which are manufactured by Motorola Corp; the 6035 or the 7135, manufactured by Kyocera; the i300 or i330, manufactured by Samsung Electronics Co., Ltd; the TREO 180, 270, 600, 650, 680, 700p, 700w, or 750 smart phone manufactured by Palm, Inc; any computing device that has different processors, operating systems, and input devices consistent with the device; or any other mobile computing device capable of performing the methods and systems described herein.

Still other embodiments of the client machine include a mobile client machine that can be any one of the following: any one series of Blackberry, Playbook or other handheld device manufactured by Research In Motion Limited; the iPhone manufactured by Apple Computer; Windows Phone 7, HTC, Sony Ericsson, any telephone or computing device running the Android operating system, or any handheld or smart phone; a Pocket PC; a Pocket PC Phone; or any other handheld mobile device supporting Microsoft Windows Mobile Software, etc.

The client machine may include a display and a touch-sensitive surface. It should be understood, however, that the computing device may also include one or more other physical user interface devices, such as a physical keyboard, a mouse and/or a joystick.

The client machine may be in communication with a remote server via a communication network. In another implementation, the data may be loaded from a local database or from local data files e.g. XML, JSON etc.

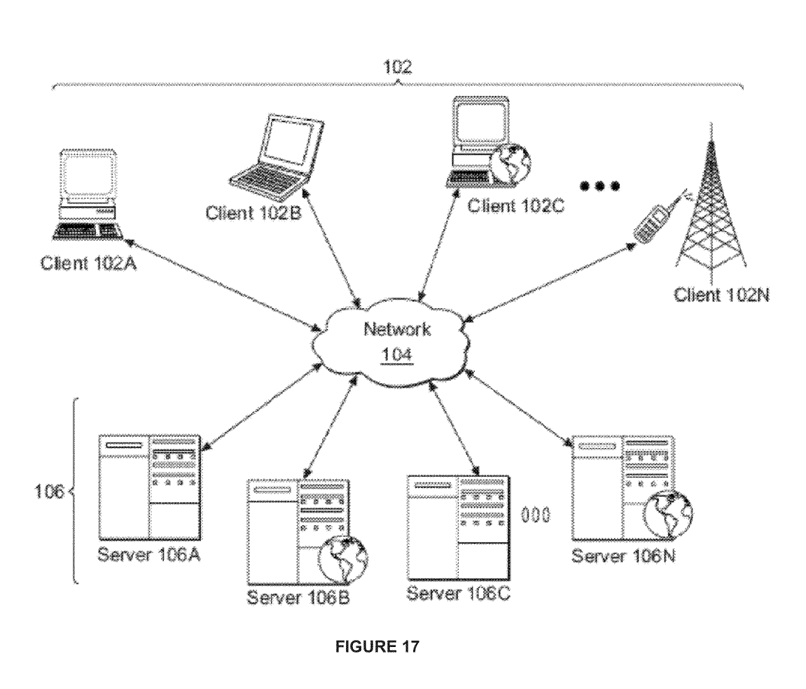

FIG. 17 illustrates an embodiment of a computing environment 101 that includes one or more client machines 102A-102N in communication with servers 106A-106N, and a network 104 installed in between the client machines 102A-102N and the servers 106A-106N. In some embodiments, client machines 102A-10N may be referred to as a single client machine 102 or a single group of client machines 102, while servers may be referred to as a single server 106 or a single group of servers 106. One embodiment includes a single client machine 102 communicating with more than one server 106, another embodiment includes a single server 106 communicating with more than one client machine 102, while another embodiment includes a single client machine 102 communicating with a single server 106.

The client machine 102 may in some embodiments execute, operate or otherwise provide an application that can be any one of the following: software; a program; executable instructions; a web browser; a web-based client; a client-server application; a thin-client computing client; an ActiveX control; a Java applet; software related to voice over internet protocol (VoIP) communications like a soft IP telephone; an application for streaming video and/or audio; an application for facilitating real-time-data communications; a HTTP client; a FTP client; an Oscar client; a Telnet client; or any other type and/or form of executable instructions capable of executing on client machine 102. Still other embodiments may include a computing environment 101 with an application that is any of either server-based or remote-based, and an application that is executed on the server 106 on behalf of the client machine 102. The client machine 102 may include a network interface to interface to a Local Area Network (LAN), Wide Area Network (WAN) or the Internet through a variety of connections including, but not limited to, standard telephone lines, LAN or WAN links (e.g., 802.11, T1, T3, 56 kb, X.25, SNA, DECNET), broadband connections (e.g., ISDN, Frame Relay, ATM, Gigabit Ethernet, Ethernet-over-SONET), wireless connections, or some combination of any or all of the above.

The computing environment 101 can in some embodiments include a server 106 or more than one server 106 configured to provide the functionality of any one of the following server types: a file server; an application server; a web server; a proxy server; an appliance; a network appliance; a gateway; an application gateway; a gateway server; a virtualization server; a deployment server; a SSL VPN server; a firewall; a web server; an application server or as a master application server; a server 106 configured to operate as an active direction; a server 106 configured to operate as application acceleration application that provides firewall functionality, application functionality, or load balancing functionality, or other type of computing machine configured to operate as a server 106. In some embodiments, a server 106 may include a remote authentication dial-in user service such that the server 106 is a RADIUS server.

The network 104 between the client machine 102 and the server 106 is a connection over which data is transferred between the client machine 102 and the server 106. Although the illustration in FIG. 14 depicts a network 104 connecting the client machines 102 to the servers 106, other embodiments include a computing environment 101 with client machines 102 installed on the same network as the servers 106. Other embodiments can include a computing environment 101 with a network 104 that can be any of the following: a local-area network (LAN); a metropolitan area network (MAN); a wide area network (WAN); a primary network comprised of multiple sub-networks located between the client machines 102 and the servers 106; a primary public network with a private sub-network; a primary private network with a public sub-network; or a primary private network with a private sub-network. Still further embodiments include a network 104 that can be any of the following network types: a point to point network; a broadcast network; a telecommunications network; a data communication network; a computer network; an ATM (Asynchronous Transfer Mode) network; a SONET (Synchronous Optical Network) network; a SDH (Synchronous Digital Hierarchy) network; a wireless network; a wireline network; a network 104 that includes a wireless link where the wireless link can be an infrared channel or satellite band; or any other network type able to transfer data from client machines 102 to servers 106 and vice versa to accomplish the methods and systems described herein. Network topology may differ within different embodiments, possible network topologies include: a bus network topology; a star network topology; a ring network topology; a repeater-based network topology; a tiered-star network topology; or any other network topology able transfer data from client machines 102 to servers 106, and vice versa, to accomplish the methods and systems described herein. Additional embodiments may include a network 104 of mobile telephone networks that use a protocol to communicate among mobile devices, where the protocol can be any one of the following: AMPS; TDMA; CDMA; GSM; GPRS UMTS; or any other protocol able to transmit data among mobile devices to accomplish the systems and methods described herein.

While preferred embodiments have been described above and illustrated in the accompanying drawings, it will be evident to those skilled in the art that modifications may be made without departing from this disclosure. Such modifications are considered as possible variants comprised in the scope of the disclosure.

1. A graphical user interface (interface) on a computing device comprising a memory having stored thereon computer instructions and a queue for storing search results and a coefficient for each search result indicating a relevance of that search result to a search query, and a processor for executing the instructions for implementing the interface on a display device, the interface comprising:
a display area for displaying search results having the highest coefficients; and
a periphery surrounding the display area, the periphery comprising an edge at or near the periphery having a function associated therewith, the function indicating a user preference;
wherein the function is activated by dragging a search result toward the edge.

2. The interface of claim 1, wherein the edge is divided into portions and different functions are associated with different edge portions, each function being activated when a search result is dragged toward the edge portion associated with that function.

3. The interface of claim 2, wherein a first function associated with a first edge portion indicates that the user likes the dragged search result, wherein when the first function is activated the interface causes the computing device to:
increase the coefficient of the dragged search result;
modify the coefficient of each search result related to the dragged search result in accordance with a similarity factor between the dragged search result and the related search result;
reorder the queue in accordance with the modified coefficients;
modify the search results displayed in the display area based on the reordered queue.

4. The interface of claim 3, wherein a second function associated with a second edge portion indicates that the user dislikes the dragged search result, wherein when the second function is activated the interface causes the computing device to:
decrease the coefficient of the dragged search result;
modify the coefficient of each search result related to the dragged search result in accordance with a similarity factor between the dragged search result and the related search result;
reorder the queue in accordance with the modified coefficients;
modify the search results displayed in the display area based on the reordered queue.

5. The interface of claim 4, wherein the search results comprise products having a specification sheet, wherein the search results may be refined by opening a specification sheet associated with a selected product and dragging a product characteristic listed in the specification sheet toward a desired edge portion to activate the function associated with the desired edge portion.

6. The interface of claim 4, wherein the interface displays the search results, as icons representative thereof, in a cluster of icons including a visual link between icons having a common characteristic, and a tag indicating the common characteristic, the tag being associated with the visual link.

7. The interface of claim 6, wherein the search results may be refined by dragging the tag toward a desired edge portion, wherein the coefficients of the search results having the characteristic displayed in the dragged tag as a common characteristic are modified in accordance with the user preference associated with the desired edge portion.

8. The interface of claim 6, wherein a number of icons displayed in the display area depends on a space allocated for the interface on the display device.

9. The interface of claim 6, wherein for at least one edge portion of the first edge portion and the second portion, the interface causes the computing device to:
associate a first score to a first end of the at least one edge portion, the first score representing the lowest degree of liking in the first edge portion or disliking in the second edge portion;
associate a second score to a second end of the at least one edge portion, the second score representing the highest degree of liking in the first edge portion or disliking in the second edge portion;
detect an intersection point between a dragging trajectory of the dragged icon and the at least one edge portion;
modify the coefficient of the search result represented by the dragged icon in accordance with a position of the intersection point between the first end and the second of the at least one edge portion.

10. The interface of claim 6, wherein the function is activated when the dragged icon is brought in contact with, or within a predetermined distance of the selected edge portion.

11. The interface of claim 6, wherein the function is activated when the dragged icon is accelerated and released toward the destination edge portion, the interface causing the computing device to:
measure a direction of movement of the dragged node to determine the destination edge;
measure an acceleration of a dragging movement; and
activate the function associated with the destination edge portion when the acceleration exceeds a predetermined threshold.

12. The interface of claim 6, wherein when an icon is dragged toward a destination edge portion, the interface causes the computing device to:
measure a direction of movement of the dragged icon to determine the destination edge portion;
provide a visual indicator indicating the destination edge portion and the function associated therewith.

13. The interface of claim 2, wherein the interface may be personalized by associating the desired function and user preference to the desired edge portion.

14. The interface of claim 2, wherein the user preference is one of: like, dislike, discard, ignore, buy, preview, and share.

15. The interface of claim 6, wherein the icons represent products comprising one or more of author, singer, dancer, music composer, band, actor, music album, song, painting, book, movie, game, electronic device, a property which describes the product, and a person's name or picture.

16. A graphical user interface (interface) on a computing device comprising a memory and a processor for executing computer instructions stored on the memory for implementing the interface in a web browser on a display device, the interface comprising:
a display area for displaying search results returned in response to a search query;
an edge surrounding at least a portion of the display area, the edge having a function associated therewith, the function being activated when one or more keywords/links within the search results are dragged toward the edge;
wherein when the function is activated, the interface performs a new search with a new search query based on the selected keywords and a user preference associated with the function.

17. The interface of claim 16, wherein if the user preference indicates that the user likes the dragged keywords, the new search query comprises or consists of the selected keywords.

18. The interface of claim 17, wherein if the user preference indicates that the user dislikes the dragged keywords, the new search excludes search results including the selected keywords.

19. A method for performing a product search on a computing device, the method comprising:
receiving and storing a list of products returned by the search and a list of coefficients associated with the products;
displaying products having the highest coefficients, as icons representative thereof, in a display area defined by an edge on a display device;
associating a function indicating a user preference to the edge;
detecting the dragging of an icon toward the edge;
activating the function after the dragging;
adjusting the coefficients of products related to the dragged product in accordance with the user preference associated with the edge;
refining the icons displayed in the search interface based on the adjusted coefficients.

20. The method of claim 19, further comprising displaying the icons in a cluster including a visual link between icons representing products having a common characteristic, and displaying the common characteristic in a tag associated with the visual link.
